(19) United States
(12) Patent Application Publication
(10) Pub. No.: US 2016/0180291 A1
(43) Pub. Date: Jun. 23, 2016

(54) RETENTION RISK MITIGATION SYSTEM

(71) Applicant: Workday, Inc., Pleasanton, CA (US)

(72) Inventors: Daniel Walter Beck, Menlo Park, CA (US); Mohammad Sabah, San Jose, CA (US); Adeyemi Ajao, San Francisco, CA (US); James Fan, San Mateo, CA (US); Parag Avinash Namjoshi, Redwood City, CA (US); Vivek Tawde, San Francisco, CA (US)

(21) Appl. No.: 14/578,978

(22) Filed: Dec. 22, 2014

(51) Int. Cl. G06Q 10/10; G06Q 10/06

(52) U.S. Cl. CPC G06Q 10/1053; G06Q 10/0635; G06Q 10/067

(57) ABSTRACT

A system for rating job transitions includes a probability determiner for determining a set of probabilities, a grouper for determining a group of job transition histories, a filter for determining a subset of job transition histories from the group of job transition histories by filtering based at least in part on a transition characteristic, a normalizer for determining a model set of job transition histories by normalizing the subset of job transition histories, a feature vector extractor for determining a set of feature vectors using the model set of job transition histories, a model builder for determining a model based at least in part on the set of feature vectors, and a rater for rating potential job transitions of a selected employee based on the model using a set of test feature vectors.

### BACKGROUND OF THE INVENTION

A large business may employ many people with different job functions. Across their career, employees can have many employment transitions between job functions. Some employees stay in the same job function for a long period of time, some change function more often. However, a company invests significantly in its employees. So, if an employee leaves the company, the business loses both time and money as it replaces the employee that has just left.

### BRIEF DESCRIPTION OF THE DRAWINGS

Various embodiments of the invention are disclosed in the following detailed description and the accompanying drawings.

FIG. 1 is a block diagram illustrating an embodiment of a network system.

FIG. 2 is a block diagram illustrating an embodiment of an employee data server.

FIG. 3 is a block diagram illustrating an embodiment of a retention risk mitigation system.

FIG. 4 is a diagram illustrating an embodiment of a transaction.

FIG. 5 is a diagram illustrating an embodiment of a feature vector.

FIG. 6A is a diagram illustrating an embodiment of a job hierarchy.

FIG. 6B is a diagram illustrating an embodiment of hierarchical job function clustering.

FIG. 7 is a flow diagram illustrating an embodiment of a process for mitigating retention risk.

FIG. 8 is a flow diagram illustrating an embodiment of a process for determining a set of probabilities, wherein each probability of the set of probabilities comprises a ratio of a number of transitions from a first job to a second job divided by a number of total employees in the first job.

FIG. 9 is a flow diagram illustrating an embodiment of a process for determining a group of job transition histories wherein each job transition history is associated with one employee

FIG. 10 is a flow diagram illustrating an embodiment of a process for filtering a group of job transition histories to determine a subset of job transition histories based at least in part on a transition characteristic.

FIG. 11A is a flow diagram illustrating an embodiment of a process for determining a model set of job transition histories by normalizing a subset of job transition histories.

FIG. 11B is a flow diagram illustrating an embodiment of a process for normalizing a job transition.

FIG. 12 is a flow diagram illustrating an embodiment of a process for determining a set of feature vectors, wherein each feature vector is based at least in part on a job transition history of an employee and on a set of probabilities.

FIG. 13 is a flow diagram illustrating an embodiment of a process for rating job transitions of a selected employee based on a model, using a set of test feature vectors.

FIG. 14 is a diagram illustrating an embodiment of a user interface for a retention risk mitigation system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for rating job transitions is disclosed. The system for rating job transitions comprises a probability determiner for determining a set of probabilities, wherein each probability of the set of probabilities comprises a ratio of a number of transitions from a first job to a second job divided by a number of total employees in the first job; a grouper for determining a group of job transition histories wherein each job transition history is associated with one employee; a filter for determining a subset of job transition histories from the group of job transition histories by filtering based at least in part on a transition characteristic; a normalizer for determining a model set of job transition histories by normalizing the subset of job transition histories; a feature vector extractor for determining a set of feature vectors wherein each feature vector is based at least in part on a job transition history of an employee and on the set of probabilities; a model builder for determining a model based at least in part on the set of feature vectors; and a rater for rating job transitions of a selected employee based on the model, using a set of test feature vectors.

A system for mitigating retention risk is disclosed. In some embodiments, the system for mitigating retention risk receives a set of employee transaction data (e.g., employee title changes, employee job function changes, employee location changes, company division changes, employee salary changes, etc.) and creates a model for determining the chance or risk that a given employee will leave the company (e.g., within the next year) based on associated employee job title or job function transitions. In various embodiments, employee transaction data comprises data regarding employee promotions, location changes, job title changes, job function changes, manager changes, pay changes, shift changes, hiring, firing, layoffs, voluntarily leaving, or any other appropriate employee transaction data. The system for mitigating retention risk groups job transitions into job transition histories by employee (e.g., a job transition history comprises the history of job function transitions for an employee—for example, hiring, a pay raise, a promotion, a location change, another pay raise, another promotion, a manager change, a voluntary leave, etc.). The set of job transition histories is filtered to remove employees that do not contribute useful information to the model based at least in part on transition characteristics (e.g., employees that left for reasons not related to retention practices, employees that have died, employees that have retired, employees that were hired on a temporary basis, contractors, employees that only stayed at the company for a very short time, employees that have changed from one location to another but keeping the same position, employees that are reorganized and have a title and/or location change where nothing else has changed, etc.). A model set of job transition histories is then determined from the filtered set of job transition histories by normalization. In some embodiments, normalization comprises determining a normalized job function or job title with the transaction. In some embodiments, a normalized job function or job title comprises a job function or job title selected from a set of normalized job functions or job titles, wherein the set of normalized job functions or job titles is smaller than the set of job functions or job titles (e.g., normalizing job functions or job titles associated with the set of transitions reduces the total number of job functions or job titles associated with the set of transitions).

In some embodiments, a feature vector is then determined from each job transition history of the model set of job transition histories. In some embodiments, each feature of the feature vector represents whether an employee made a particular job transition. In some embodiments, each feature of the feature vector is weighted by the inverse of the probability of the job transition (e.g., the fraction of the employees with the initial job of the job transition that eventually make the job transition). In some embodiments, weighing a feature of the feature vector by the inverse of the probability of the job transition reduces the influence of common transitions and increases the influence of uncommon transitions. In some embodiments, each feature of the feature vector is weighted by a factor relating to the time since the job transition. In some embodiments, the factor decreases according to an exponential decay function with time. In some embodiments, weighing the feature of the feature vector by the factor relating to the time since the job transition reduces the influence of old transitions and increases the influence of new transitions. A model is built using machine learning algorithms (e.g. Support Vector Machine) on the set of job transition histories and the set of feature vectors determined from the set of job transition histories to predict retention risk. The prediction of future retention risk is based on the feature vector calculated above of normalized job function or job title transitions. In some embodiments, supervised learning models are used wherein each feature vector comprises a label that represents whether the associated employee left the company voluntarily. The supervised learning model determines a weight for each feature (e.g., each job transition) that shows the influence and correlation of the feature on the retention risk and provides the best accuracy on predicting retention risk. In some embodiments, we use cross validation to measure the statistical significance and accuracy of prediction—for example, by having the model train on a first set of employee feature vectors and apply the feature weights on a second set of employee feature vectors. The first set of employee feature vectors and the second set of employee feature vectors are non-overlapping to avoid bias in training and to make the model generalizable. The trained models are applied to determine the probability that an active employee, represented by a job transition history and a feature vector, will leave the company in the next year. Once the retention model is built, a predictor can use the model to determine retention risk for a given employee. The predictor receives a job transition history associated with the given employee, normalizes the job transition history, determines a feature vector from the normalized job transition history, and makes a retention risk prediction based on the feature vector and the model.

The system for mitigating retention risk additionally comprises a rater for rating job transitions of a selected employee. In some embodiments, the rater receives an indication of a selected employee and rates possible job transitions for the selected employee. The rater determines a feature vector for the selected employee (e.g., by determining a job transition history for the employee, representing each transition of the job transition history in a feature vector, and weighing each feature of the vector based at least in part on job transition probability or time since the job transition occurred). The rater then determines a set of possible job transitions (e.g., the possible job transitions from the current job). In some embodiments, the set of possible job transitions is limited to those for which data is present (e.g., in the event a job transition has never been made in the past, it is not considered by the rater). A test feature vector is created for each job transition of the set of possible job transitions. The test feature vector comprises the feature vector representing the selected employee having just made the associated job transition (e.g., the associated job transition is added to the feature vector representing the employee). The predictor is then used to predict the retention risk associated with each test feature vector and with the original feature vector associated with the employee. In some embodiments, rating retention risk associated with a job transition comprises determining the relative retention risk change associated with the job transition (e.g., the difference in the retention risk associated with the original feature vector and the retention risk associated with the feature vector including the job transition).

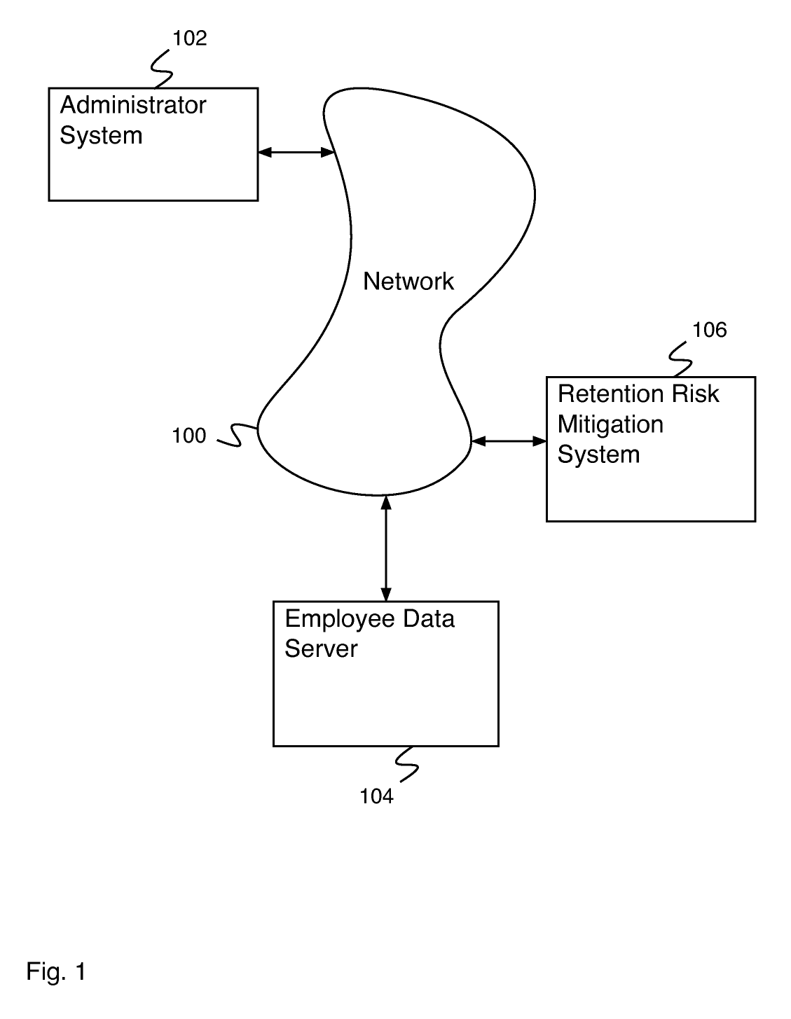

FIG. 1 is a block diagram illustrating an embodiment of a network system. In some embodiments, the network system of FIG. 1 comprises a system for mitigating retention risk. In the example shown, FIG. 1 comprises network 100. In various embodiments, network 100 comprises one or more of the following: a local area network, a wide area network, a wired network, a wireless network, the Internet, an intranet, a storage area network, or any other appropriate communication network. Administrator system 102, employee data server 104, and retention risk mitigation system 106 communicate via network 100. In various embodiments, administrator system 102 comprises a system for an administrator to access data on employee data server 104, to determine retention risk using retention risk mitigation system 106, or for any other appropriate purpose. Employee data server 104 comprises a system for storing employee data. In some embodiments, employee data server 104 comprises a system for storing employee data for a company. In various embodiments, employee data server 104 comprises a system for storing current employee data, past employee data, employee transaction data, or any other appropriate employee data. Retention risk mitigation system 106 comprises a system for determining retention risk. In some embodiments, retention risk determiner comprises a system for building a model to determine retention risk. In some embodiments, a model to determine retention risk is based at least in part on data stored in employee data server 104. In some embodiments, retention risk mitigation system 106 comprises a system to determine retention risk for a given employee based at least in part on a model. In some embodiments, retention risk mitigation system 106 uses historic data from employee data server 104 regarding employees to build and test a model for retention and using the model to determine retention risk for a given employee. In some embodiments, retention risk mitigation system 106 comprises a system for rating job transitions. In some embodiments, the system for rating job transitions determines a set of possible job transitions and uses the model to determine the retention risk for the employee after making each of the possible job transitions. A job transition rating comprises the change in retention risk resulting from the job transition.

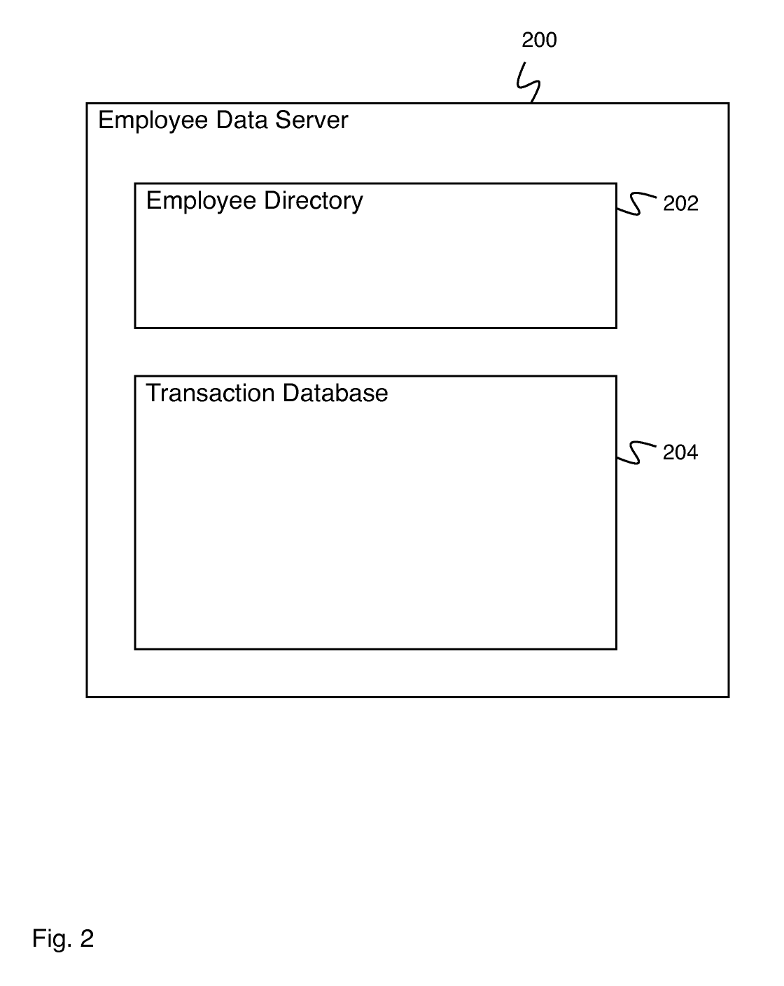

FIG. 2 is a block diagram illustrating an embodiment of an employee data server. In some embodiments, employee data server 200 comprises employee data server 104 of FIG. 1. In the example shown, employee data server 200 comprises employee directory 202 and transaction database 204. Employee directory 202 comprises employee information. In various embodiments, employee information comprises employee name, an employee identifier, employee job title, employee division, employee location, employee salary, employee supervisor, employee age, or any other appropriate employee information. Transaction database 204 comprises a set of employee transactions. In some embodiments, an employee transaction comprises a record of an employee event. In various embodiments, an employee event comprises hiring, firing, promotion, demotion, changing groups, changing locations, changing salary rate, changing supervisor, retirement, death, or any other appropriate employee event. In some embodiments, a transaction comprises a record of employee information before and after the employee event.

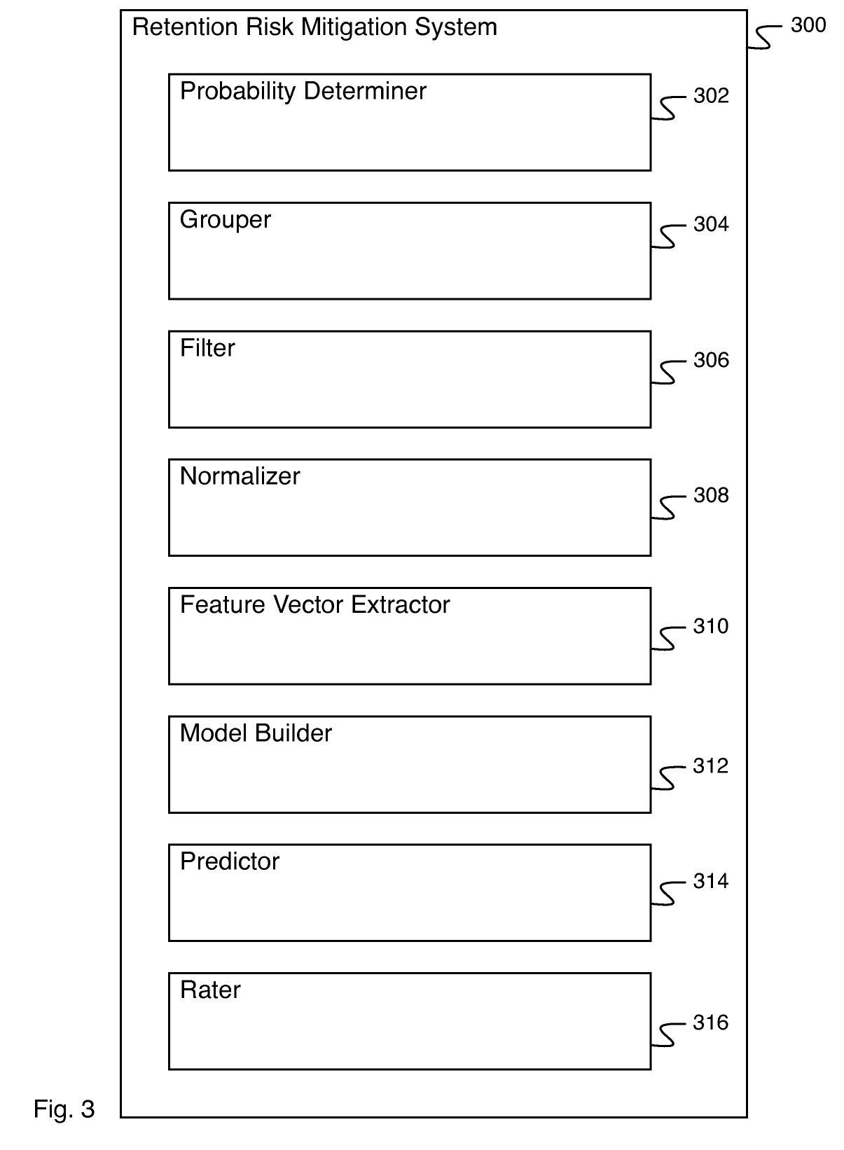

FIG. 3 is a block diagram illustrating an embodiment of a retention risk mitigation system. In some embodiments, retention risk mitigation system 300 comprises retention risk mitigation system 106 of FIG. 1. In the example shown, retention risk mitigation system 300 comprises probability determiner 302. In some embodiments, probability determiner 302 determines the probability of one or more job transitions. In some embodiments, the probability of a job transition is determined based on its statistical likelihood (e.g., the probability of a job transition from a first job function to a second job function is determined to be the fraction of people with the first job function that make the transition to the second job function). In some embodiments, probability determiner 302 is implemented using a processor. In the example shown, retention risk mitigation system 300 comprises grouper 304. In some embodiments, grouper 304 comprises a grouper for grouping employee job transitions with one employee into a job transition history. In some embodiments, grouper 304 is implemented using a processor. Retention risk determiner 300 additionally comprises filter 306. In some embodiments, filter 306 comprises a filter for filtering employees based at least in part on a transition characteristic to remove employees that do not contribute useful information to the model (e.g., for removing a job transition history associated with an employee from a set of job transition histories). In various embodiments, the filter comprises a filter for removing employees using one or more of the following transition characteristics: the characteristics that an employee is retired, an employee died, an employee only worked at the company a short time, an employee was hired on a temporary basis, contractors, or any other appropriate transition characteristic. In some embodiments, filter 304 is implemented using a processor. Retention risk determiner 300 additionally comprises normalizer 308. In some embodiments, normalizer 308 comprises a normalizer for normalizing transitions. In some embodiments, normalizing a transition comprises determining a normalized transition initial job function or job title associated with a transition initial job function or job title or determining a normalized transition final job function or job title associated with a transition final job function or job title. In some embodiments, normalizer 308 is implemented using a processor.

In the example shown, retention risk determiner 300 additionally comprises feature vector extractor 310. In some embodiments, feature vector extractor 310 comprises a feature vector for extracting a feature vector from a time series. In some embodiments, extracting a feature vector from a time series comprises determining a set of features from a job transition history. In some embodiments, each feature of a feature vector corresponds to a possible job transition. In some embodiments, the weight of a feature of a feature vector is zero in the event the employee associated with the feature vector did not make the transition associated with the feature. In some embodiments, the weight of a feature of a feature vector is based at least in part on a transition probability and a transition time in the event the employee associated with the feature vector made the transition associated with the feature. In some embodiments, feature vector extractor 308 is implemented using a processor. Retention risk determiner 300 additionally comprises model builder 312. In some embodiments, model builder 312 receives a set of feature vectors and builds one or more models. In some embodiments, a model comprises a weight vector. In some embodiments, model builder 312 is implemented using a processor.

In some embodiments, a feature vector of the set of feature vectors is generated using job transition data associated with an employee and the model is trained using the set of feature vectors and a set of targets. The set of targets indicates the retention risk. In some embodiments, a target is a zero or a one based on whether the associated employee was retained or not retained after the transition (e.g., within a time period—for example, within a year). In some embodiments, a target is weighted more positively in the event that the employee is retained longer than a period of time (e.g., the period of time is one year, the period of time is a median time an employee stays with the employer, etc.), and the target is weighted more negatively in the event that the employee is retained shorter than the period of time. In various embodiments, a plurality of models are built and trained (e.g., a model for all employees, a model for employees of a subgroup—for example, a subgroup comprises a set of employees in a job function, in a department, at a level of employment (manager, director, officer, staff, etc.), or any other appropriate model). In some embodiments, the model outputs are combined (e.g., using a linear combination, a weighted linear combination, or any other combination).

In the example shown, retention risk determiner 300 comprises predictor 314. In some embodiments, predictor 314 comprises a predictor for predicting retention risk based on a model. In some embodiments, predicting retention risk based on a model comprises computing a dot product of a feature vector and a weight vector. In some embodiments, predictor 314 is implemented using a processor.

In the example shown, retention risk determiner 300 additionally comprises rater 316. In some embodiments, rater 316 determines a set of possible next job transitions associated with a job transition history. In some embodiments, the set of possible next job transitions comprises all possible job transitions from the final job function of the job transition history. In some embodiments, the set of possible next job transitions only comprises transitions for which there is data (e.g., it does not include job transitions that have never in the past been made). In some embodiments, rater 316 determines a retention risk associated with a job transition history (e.g., utilizing feature vector extractor 310 and predictor 314). In some embodiments, rater 316 determines the retention risk associated with adding each of the possible next job transitions to the job transition history. In some embodiments, rater 316 rates a possible next job transition based at least in part on its effect on retention risk (e.g., by comparing the retention risk associated with the job transition history including the possible next job transition with the retention risk associated with the unmodified job transition history). In some embodiments, rater 316 is implemented using a processor. In various embodiments, modules of retention risk determiner 300 are all implemented on a single processor, are each implemented on separate processors, are implemented combined onto multiple processors in any appropriate way, or are implemented in any other appropriate way. In various embodiments, retention risk determiner 300 additionally comprises an input interface (e.g., for receiving job transition information), an output interface (e.g., for providing a retention risk), a bucketer (e.g., for separating time series by an employee characteristic—e.g., by time worked at the company), or any other appropriate module.

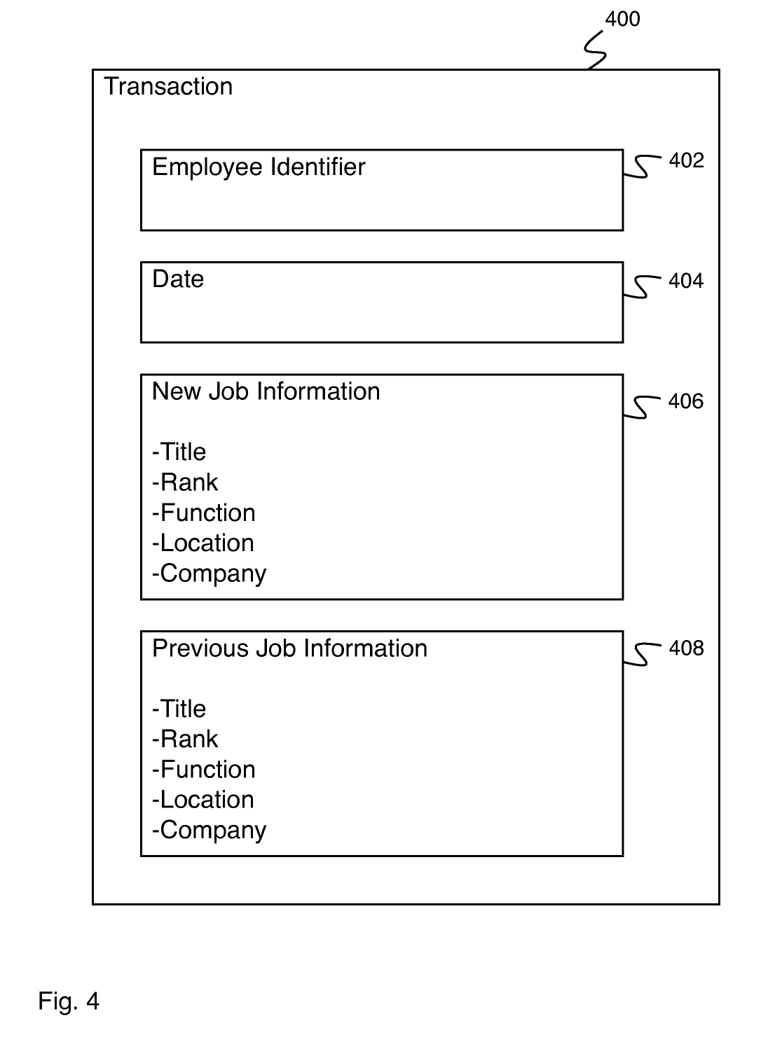

FIG. 4 is a diagram illustrating an embodiment of a transaction. In some embodiments, any appropriate number of transactions (e.g., transaction 400) are stored in a transaction database (e.g., transaction database 204 of FIG. 2). In the example shown, transaction 400 comprises employee identifier 402 (e.g., an employee ID, a unique employee identifier, etc.), date 404 (e.g., a transaction date), new job information 406, and previous job information 408. New job information 406 comprises any appropriate new job information (e.g., job title, job function, rank, location, company, supervisor, salary, shift, etc.). In some embodiments, new job information indicates a different company or no company (e.g., transaction 400 indicates the employee left the company). In some embodiments, transaction 400 indicates a job change within the company (e.g., change to a new rank, title, location, supervisor, job function, salary, etc.). Previous job information 408 comprises any appropriate previous job information (e.g., title, rank, location, company, supervisor, salary, etc.). In some embodiments, previous job information indicates a different company or no company (e.g., transaction 400 indicates that the employee joined the company.

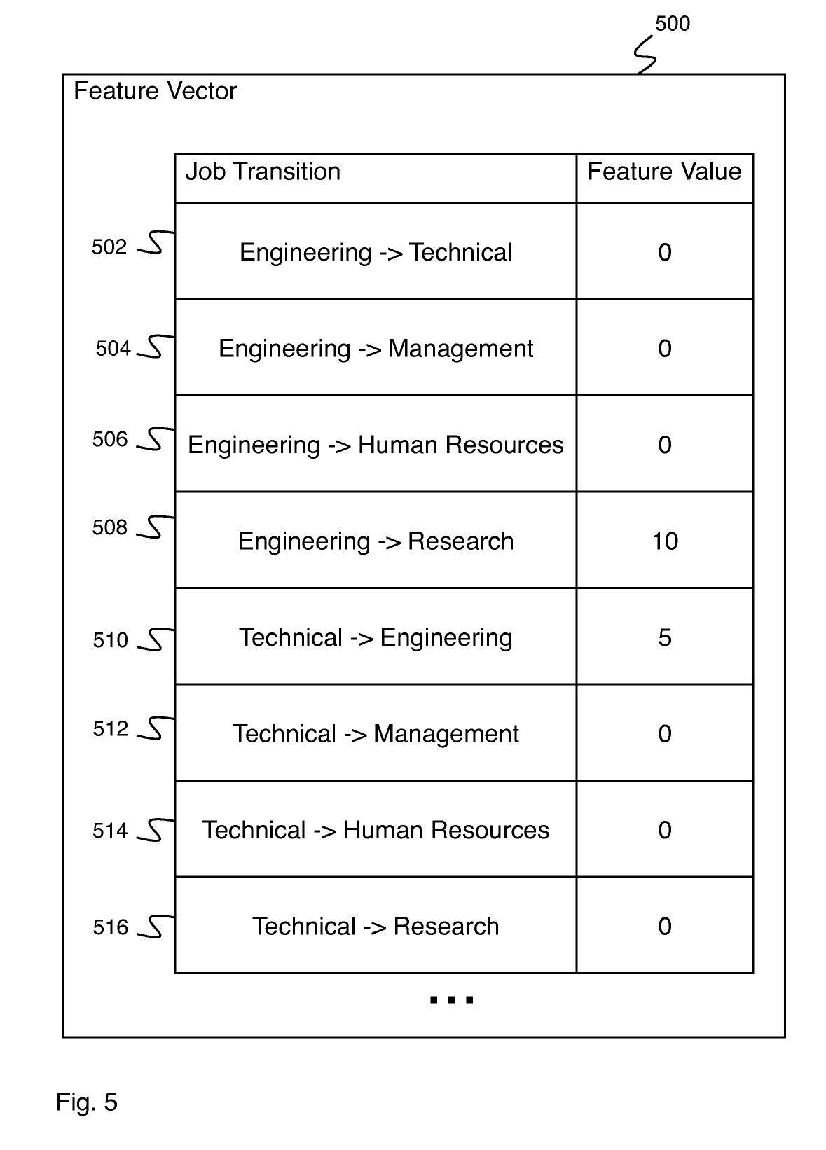

FIG. 5 is a diagram illustrating an embodiment of a feature vector. In some embodiments, feature vector 500 comprises a feature vector for representing features extracted from a transition history. In various embodiments, feature vector 500 includes all possible combinations of transitions within a company, a subset of all possible combinations of transitions within a company, all actually historically occurring transitions within a company, or any other appropriate number of transitions within a company. In the example shown, each feature of feature vector 500 represents a possible job transition within a company. In the example shown, job transition 502 represents a transition from the engineering job function or job title to the technical job function or job title. Job transition 504 represents a transition from the engineering job function or job title to the management job function or job title. Job transition 506 represents a transition from the engineering job function or job title to the human resources job function or job title. Job transition 508 represents a transition from the engineering job function or job title to the research job function or job title. Job transition 510 represents a transition from the technical job function or job title to the engineering job function or job title. Job transition 512 represents a transition from the technical job function or job title to the management job function or job title. Job transition 514 represents a transition from the technical job function or job title to the human resources job function or job title. Job transition 516 represents a transition from the technical job function or job title to the research job function or job title.

In some embodiments, feature vector 500 comprises features representing additional job function or job title transitions (e.g., transitions from the management job function or job title, transitions from the human resources job function or job title, transitions from the research job function or job title, transitions to and from other job function or job title s, etc.). In the example shown, all feature values are zero with the exception of feature 508, representing a transition from engineering to research, and feature 510, representing a transition from technical to engineering. The value associated with feature 508 is 10, indicating that the probability of a transition from engineering to research is 0.1. The value associated with feature 510 is 5, indicating that the probability of a transition from technical to engineering is 0.2. In the example shown, feature values do not take into account transition time. In some embodiments, a feature value associated with a transition decreases (e.g., linearly, exponentially, quadratically, etc.) as time passes.

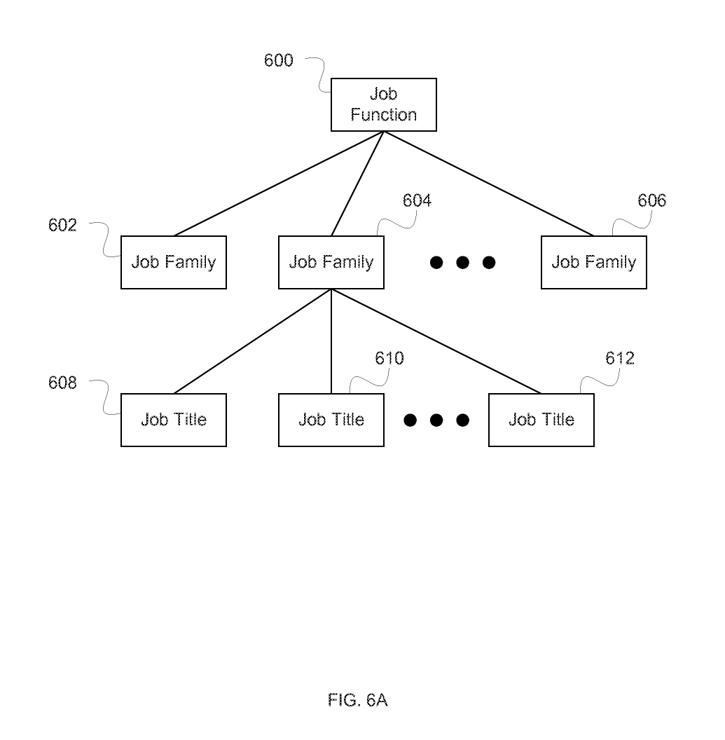

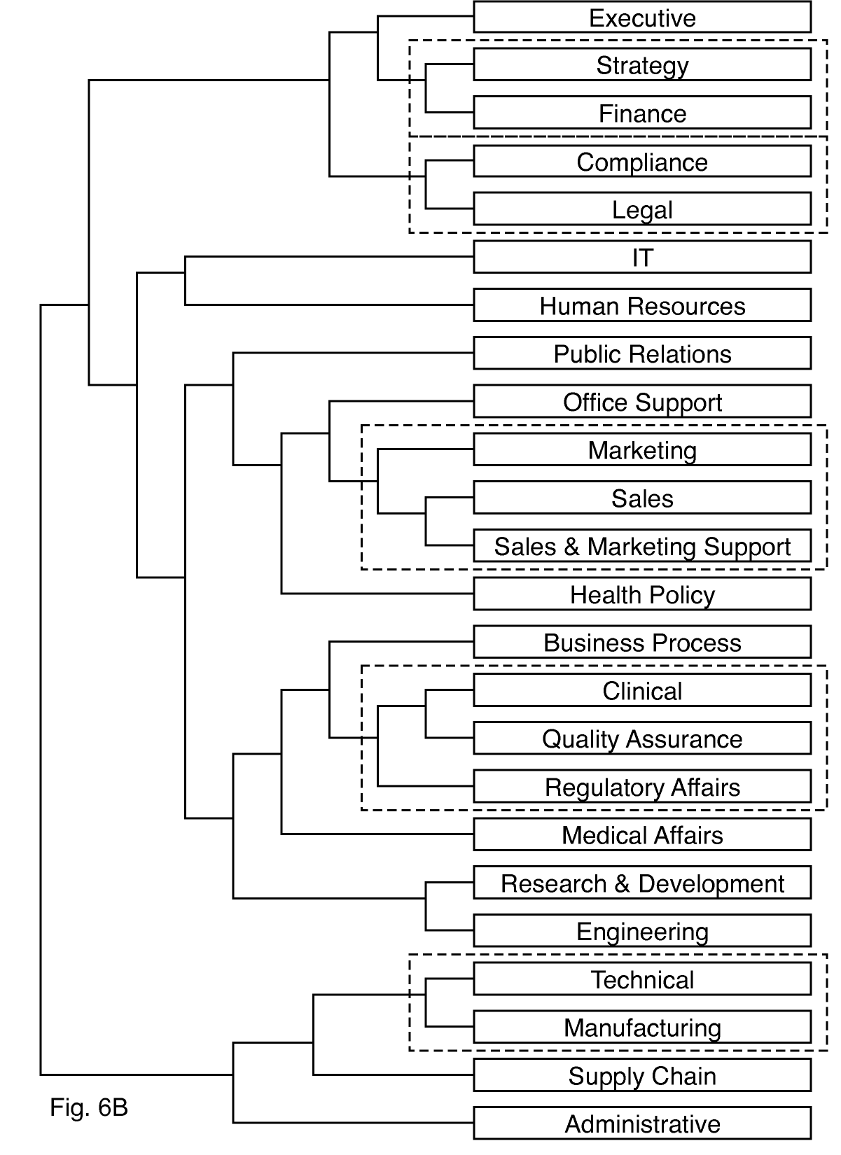

FIG. 6A is a diagram illustrating an embodiment of a job hierarchy. In the example shown, a job function 600 describes a top level business unit. For example, a department of a company such as manufacturing, operations, finance, legal, etc. Subunits of job function 600 are job families (e.g., job family 602, job family 604, and job family 606). For example, within manufacturing, a number of job families are subunits: quality assurance, packing, assembly, machinery, etc. Subunits of job family 604 are job titles (e.g., job title 608, job title 610, and job title 612). For example, within machinery there are titles Machinist 1, Machinist 2, Machinist Supervisor, etc.

FIG. 6B is a diagram illustrating an embodiment of hierarchical job function clustering. In some embodiments, hierarchical job function clustering comprises a determination of a normalized job function associated with a job title. In the example shown, the hierarchical job function tree shown in FIG. 6B comprises a job function tree comprising all job functions found at a company. In some embodiments, the total number of job functions processed e.g., by retention risk mitigation system 300 of FIG. 3 is reduced by normalization (e.g., by normalizer 308 of FIG. 3). In some embodiments, normalization comprises determining a normalized job function associated with a job title. In some embodiments, a normalized job function comprises a job title determined using hierarchical job function clustering. In the example shown, job functions are arranged into a hierarchical organization. Selected groups of job functions (e.g., indicated using dashed lines around the groups) are determined to be close in the hierarchical organization, such that their normalized job function comprises the same job function. In some embodiments, normalizing job function comprises combining several job functions into a single normalized job function to reduce the total number of job functions. In the example shown, strategy and finance are combined into a single job function; compliance and legal are combined into a single job function; marketing, sales, and sales & marketing support are combined into a single job function; clinical, quality assurance, and regulatory affairs are combined into a single job function; and technical and manufacturing are combined into a single job function. In the example shown, 24 job functions are in this way reduced to 17. In some embodiments, job titles are clustered in a similar way to reduce the total number of job titles. In some embodiments, a process for hierarchical job function clustering uses agglomerative clustering. A normalized job function is assigned corresponding to each job function. A set of steps is taken wherein in each step two job functions are merged into a normalized job function based on which two job functions are the closest in terms of job titles within job function and employees making transitions between the job functions. The process stops when titles and transitions dictate a stop (e.g., when the two job functions determined to be closest are not close enough as determined using a threshold closeness value—for example, a closeness value greater than a threshold closeness value). In some embodiments, the mapping between job function and normalized job function is stored using a table (e.g., a job function normalization table). For example, each title is mapped to a clustered title so that the overall number of titles is reduced (e.g., clustered number of titles is 50-90% original number of titles).

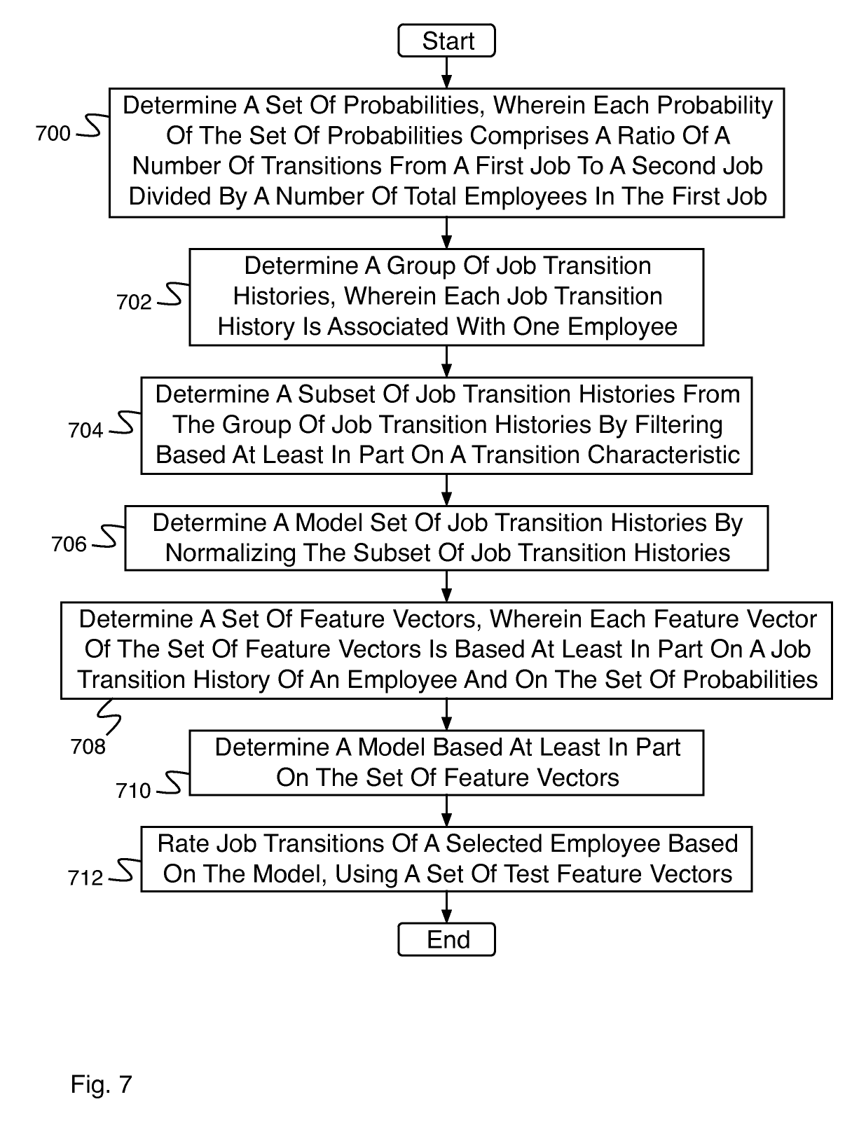

FIG. 7 is a flow diagram illustrating an embodiment of a process for mitigating retention risk. In some embodiments, the process of FIG. 7 is executed by retention risk mitigation system 106 of FIG. 1. In the example shown, in 700, a set of probabilities is determined, wherein each probability of the set of probabilities comprises a ratio of a number of transitions from a first job to a second job divided by a number of total employees in the first job. For example, the historical employment data for a company is processed to determine a set of employees that have held a first job and transitioned to a second job and this set of employees is normalized by the total number of the employees that have held the first job to determine the probability. In 702, a group of job transition histories is determined, wherein each job transition history is associated with one employee. In 704, a subset of job transition histories is determined from the group of job transition histories by filtering based at least in part on a transition characteristic. For example, the group of job transition histories are filtered based at least in part on a transition characteristic to remove employees that do not contribute useful information to the model (e.g., a transition characteristic comprises one or more of the following: employees that left for reasons not related to retention practices, employees that have died, employees that have retired, employees that were hired on a temporary basis, contractors, employees that only stayed at the company for a very short time, employees that have changed from one location to another but kept the same position, employees that are reorganized and have a title and/or location change where nothing else has changed, etc.). In 706, a model set of job transition histories is determined by normalizing the subset of job transition histories. In 708, a set of feature vectors is determined, wherein each feature vector is based at least in part on a job transition history of an employee and on the set of probabilities. In 710, a model is determined based at least in part on the set of feature vectors. In 712, potential job transitions of a selected employee are rated based on the model, using a set of test feature vectors.

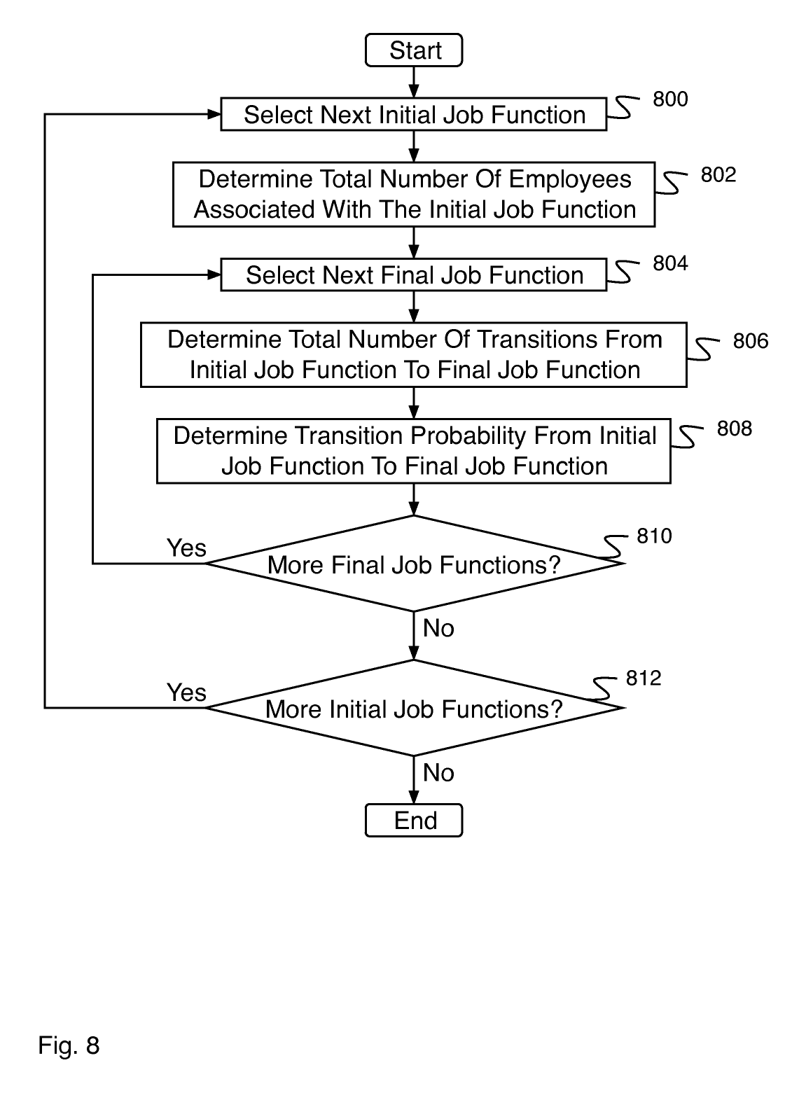

FIG. 8 is a flow diagram illustrating an embodiment of a process for determining a set of probabilities, wherein each probability of the set of probabilities comprises a ratio of a number of transitions from a first job to a second job divided by a number of total employees in the first job. In some embodiments, the process of FIG. 8 implements 700 of FIG. 7. In the example shown, in 800, the next initial job function is selected. For example, a list of all job functions at a company is compiled and the initial job is the first job in the list and each job in the list is selected in order of the list. In various embodiments, the list is in chronological order, in reverse chronological order, in no particular order, or in any other appropriate order. In some embodiments, the next initial job function comprises the first initial job function. In some embodiments, the next initial job function is selected from the set of all job functions. In 802, the total number of employees associated with the initial job function is determined. In some embodiments, the total number of employees associated with the initial job function comprises the total number of employees with a transition away from the initial job function plus the total number of employees currently in the initial job function. In 804, the next final job function is selected. In some embodiments, the next final job function comprises the first final job function. In some embodiments, the next final job function is selected from the set of all job functions less the initial job function. In 806, the total number of transitions from the initial job function to the final job function is determined (e.g., from a transaction database—for example, transaction database 204 of FIG. 2). In 808, the transition probability from the initial job function to the final job function is determined. In some embodiments, the transition probability from the initial job function to the final job function is determined by dividing the total number of transitions from the initial job function to the final job function by the total number of employees associated with the initial job function. In 810, it is determined whether there are more final job functions. In the event it is determined that there are more final job functions, control passes to 804. In the event it is determined that there are not more final job functions, control passes to 812. In 812, it is determined whether there are more initial job functions. In the event it is determined that there are more initial job functions, control passes to 800. In the event it is determined that there are not more initial job functions, the process ends.

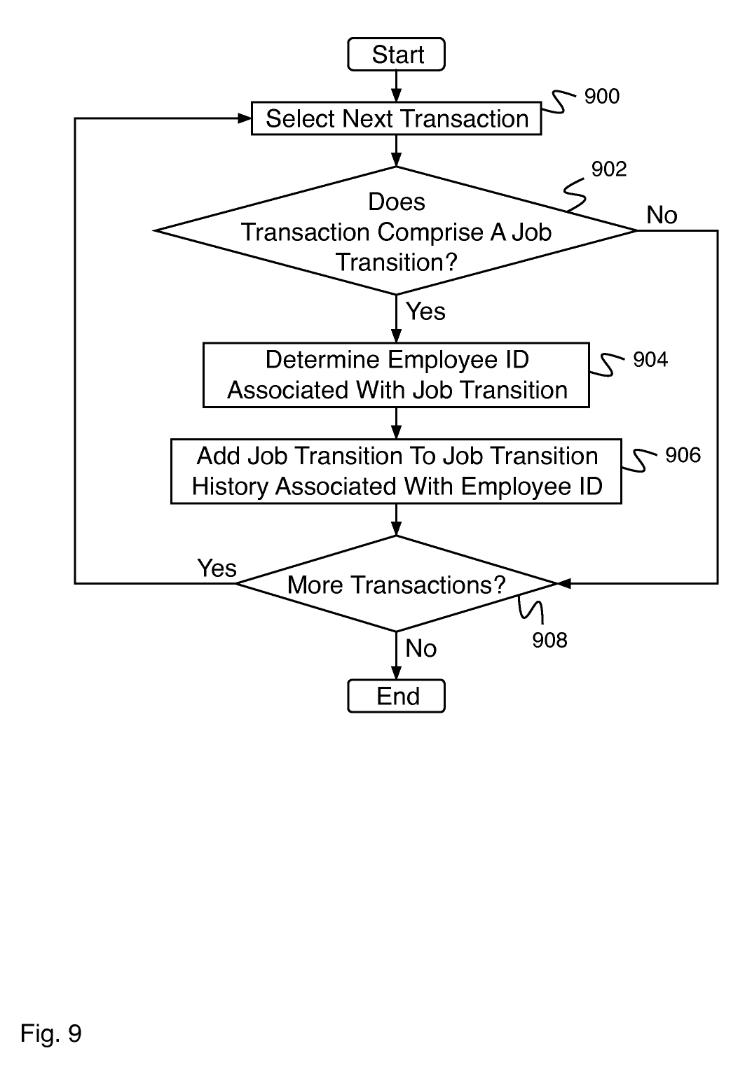

FIG. 9 is a flow diagram illustrating an embodiment of a process for determining a group of job transition histories wherein each job transition history is associated with one employee. In some embodiments, the process of FIG. 9 implements 702 of FIG. 7. In the example shown, in 900, the next transaction is selected. In some embodiments, the next transaction comprises the first transaction. In some embodiments, the next transaction comprises one of a set of transactions received from an employee data server (e.g., employee data server 104 of FIG. 1). In 902, it is determined whether the transaction comprises a job transition. In some embodiments, in the event it is determined that the transaction does not comprise a job transition, control passes to 908. In the event it is determined that the transaction comprises a job transition, control passes to 904. In 904, the employee ID associated with the job transition is determined. In 906, the job transition is added to the job transition history associated with the employee ID. In 908, it is determined whether there are more transactions. In the event there are more transactions, control passes to 900. In the event there are not more transactions, the process ends.

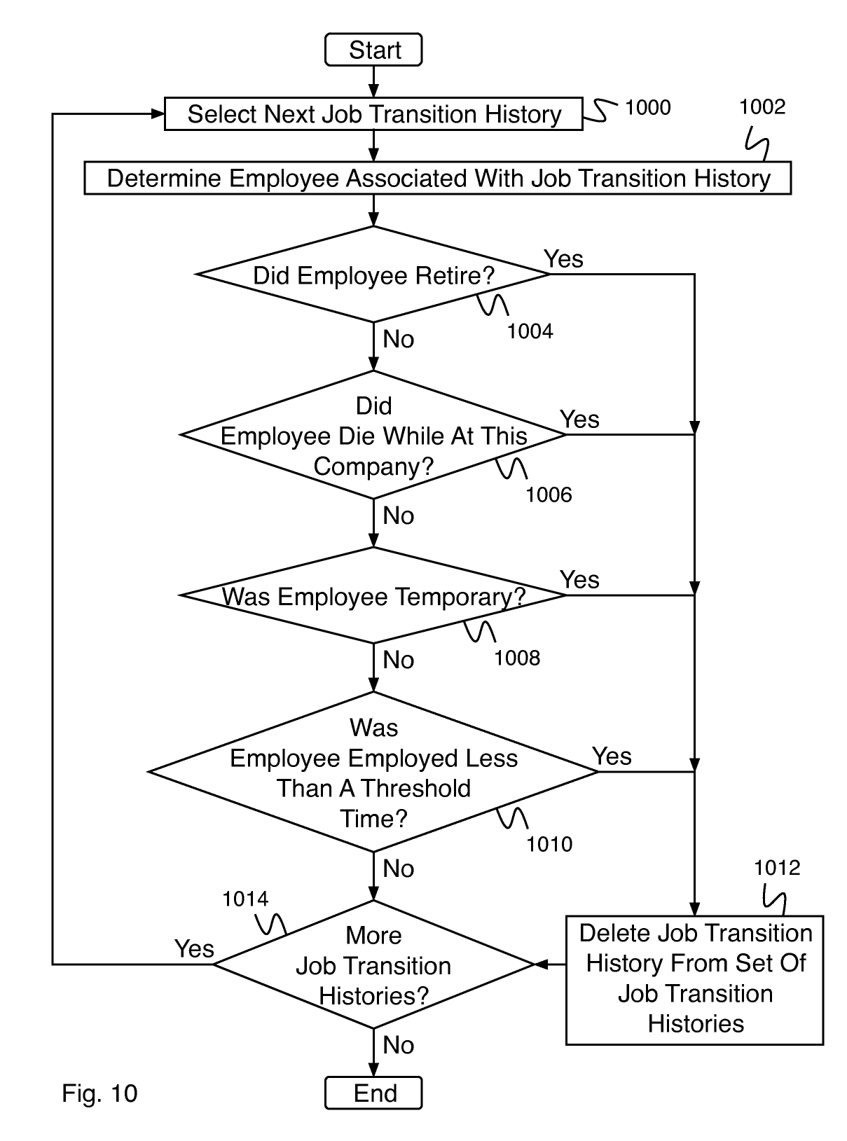

FIG. 10 is a flow diagram illustrating an embodiment of a process for filtering a group of job transition histories to determine a subset of job transition histories based at least in part on a transition characteristic. In some embodiments, the process of FIG. 10 implements 704 of FIG. 7. In some embodiments, the process of FIG. 10 filters a group of job transition histories received from a process for determining a group of job transition histories (e.g., the process of FIG. 9). In the example shown, in 1000, the next job transition history is selected. In some embodiments, the next job transition history comprises the first job transition history. In 1002, the employee associated with the job transition history is determined. In various embodiments, determining the employee comprises determining the employee name, determining an employee identifier, determining associated employee information, or determining the employee in any other appropriate way. In 1004, it is determined whether the employee retired. In the event it is determined that the employee retired, control passes to 1012. In the event it is determined that the employee did not retire, control passes to 1006. In 1006, it is determined whether the employee died while employed by this company. In the event it is determined that the employee died while employed by this company, control passes to 1012. In the event it is determined that the employee did not die while employed by this company, control passes to 1008. In 1008, it is determined whether the employee was temporary. In the event it is determined that the employee was temporary, control passes to 1012. In the event it is determined that the employee was not temporary, control passes to 1010. In 1010, it is determined whether the employee was employed for less than a threshold time. In the event it is determined that the employee was employed for less than a threshold time, control passes to 1012. In the event it is determined that the employee was not employed for less than a threshold time, control passes to 1014. In 1012, the job transition history is deleted from the group of job transition histories (e.g., the associated employee is filtered from the group of job transition histories). Control then passes to 1014. In 1014, it is determined whether there are more job transition histories. In the event it is determined that there are more job transition histories, control passes to 1000. In the event it is determined that there are not more job transition histories, the process ends.

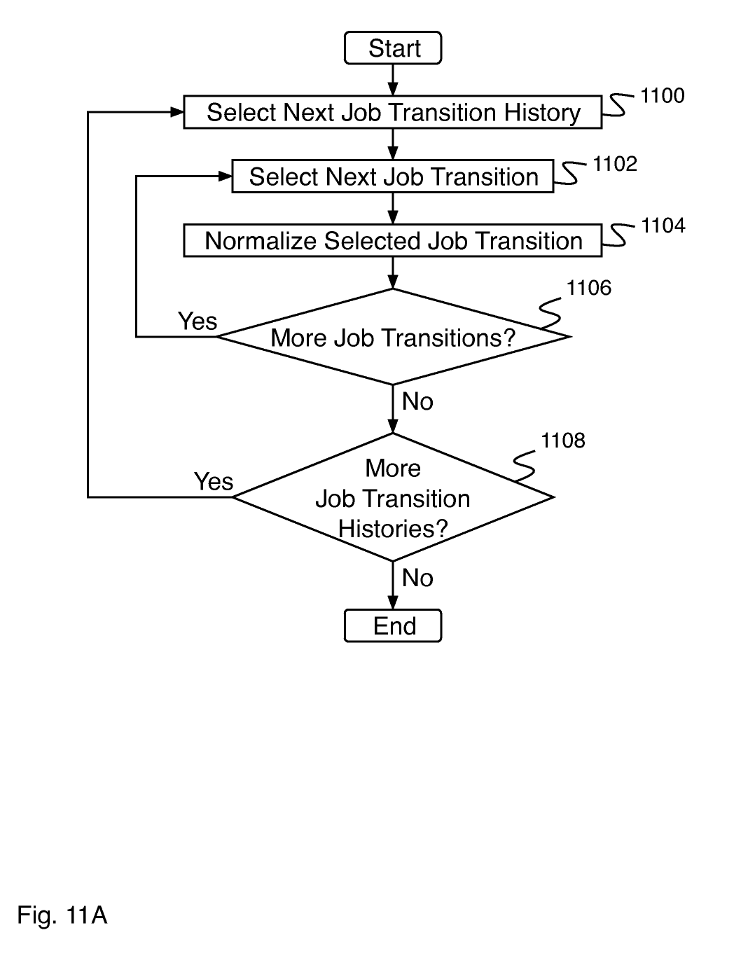

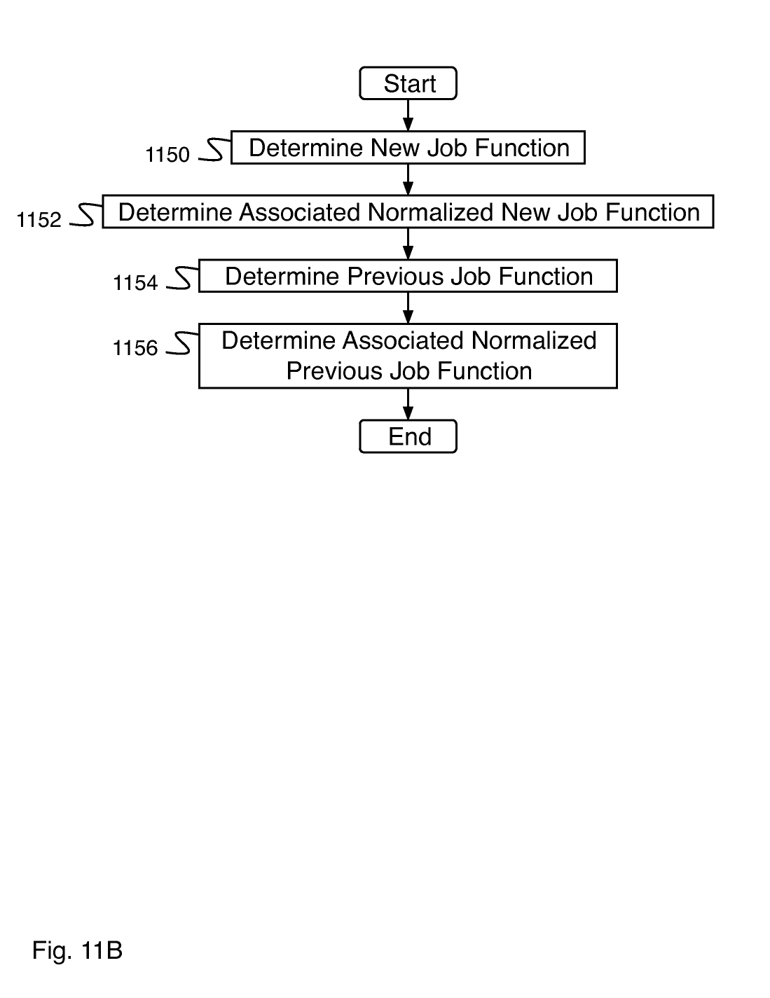

FIG. 11A is a flow diagram illustrating an embodiment of a process for determining a model set of job transition histories by normalizing a subset of job transition histories. In some embodiments, the process of FIG. 11A implements 706 of FIG. 7. In the example shown, in 1100, the next job transition history is selected. In some embodiments, the next job transition history comprises the first job transition history. In 1102, the next transition (e.g., the next transition of the selected job transition history) is selected. In some embodiments, the next transition comprises the first transition. In 1104, the selected transition is normalized. In 1106, it is determined whether there are more transitions (e.g., more transitions in the selected job transition history). In the event it is determined that there are more transitions, control passes to 1102. In the event it is determined that there are not more transitions, control passes to 1108. In 1108, it is determined whether there are more job transition histories. In the event it is determined that there are more job transition histories, control passes to 1100. In the event it is determined that there are not more job transition histories, the process ends. In some embodiments, the set of job transition histories after each transition of each job transition history has been normalized comprises a model set of job transition histories.

FIG. 11B is a flow diagram illustrating an embodiment of a process for normalizing a job transition. In some embodiments, the process of FIG. 11B implements 1104 of FIG. 11A. In the example shown, in 1150, the new job function is determined (e.g., the job function associated with the new job of the transition). In 1152, an associated normalized new job function is determined. In some embodiments, the associated normalized new job function is determined using a job function normalization table. In some embodiments, the associated normalized new job function is stored as part of the transaction. In some embodiments, the associated normalized new job function replaces the new job function in the transaction. In 1154, the previous job function is determined (e.g., the job function associated with the previous job of the transition). In 1156, an associated normalized previous job function is determined. In some embodiments, the associated normalized previous job function is determined using a job function normalization table. In some embodiments, the associated normalized previous job function is stored as part of the transition. In some embodiments, the associated normalized previous job function replaces the previous job function in the transaction.

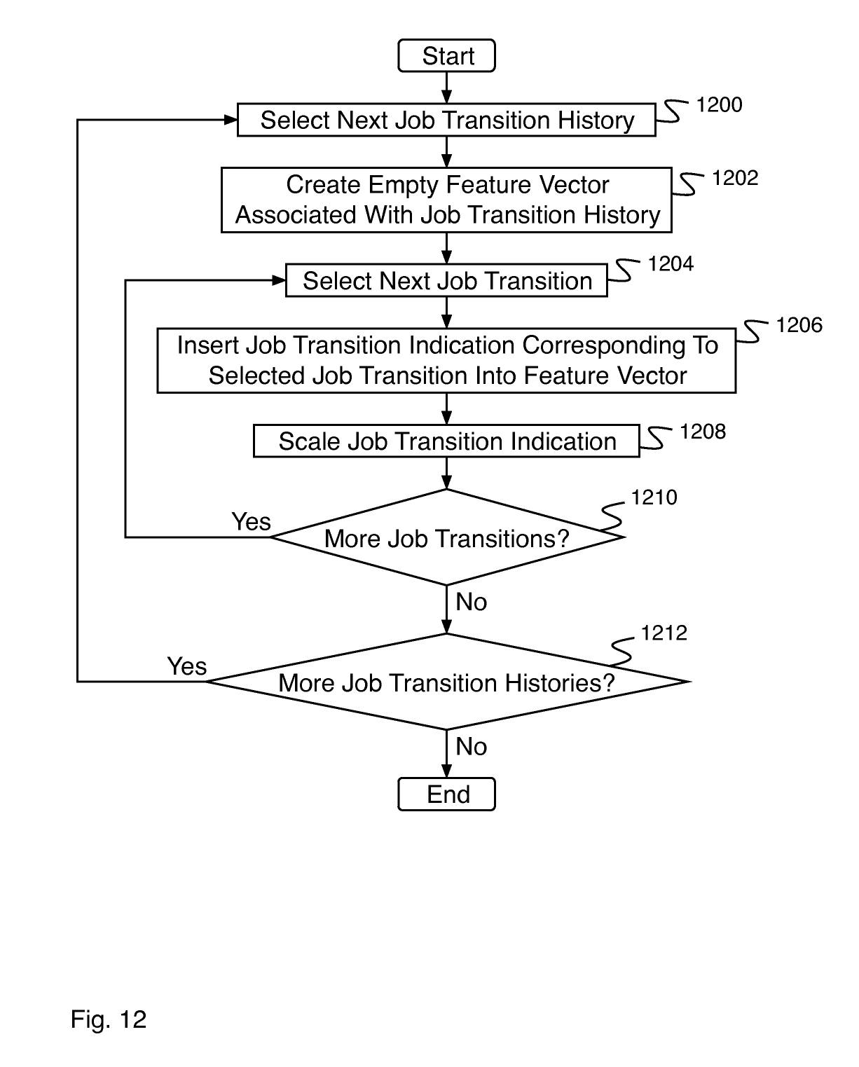

FIG. 12 is a flow diagram illustrating an embodiment of a process for determining a set of feature vectors, wherein each feature vector is based at least in part on a job transition history of an employee and on a set of probabilities. In some embodiments, the process of FIG. 12 implements 708 of FIG. 7. In the example shown, in 1200, the next job transition history is selected. In some embodiments, the next job transition history comprises the first job transition history. In 1202, an empty feature vector associated with the job transition history is created. In some embodiments, the empty feature vector comprises a set of features, each feature corresponding to a possible job transition and with a feature weight of zero. In 1204, the next job transition is selected. In some embodiments, the next job transition comprises the first job transition. In 1206, a job transition indication corresponding to the selected job transition is inserted into the feature vector. In some embodiments, inserting an indication into the feature vector comprises setting a feature weight to one. In 1208, the job transition indication is scaled. In some embodiments, scaling the job transition indication comprises dividing the job transition indication by the job transition probability. In some embodiments, scaling the job transition indication comprises multiplying the job transition indication by a scaling factor depending on the time (e.g., decaying linearly, decaying quadratically, decaying exponentially, etc. in time). In 1210, it is determined whether there are more job transitions (e.g., in the currently selected job transition history). In the event it is determined that there are more job transitions, control passes to 1204. In the event it is determined that there are not more job transitions, control passes to 1212. In 1212, it is determined whether there are more job transition histories. In the event it is determined that there are more job transition histories, control passes to 1200. In the event it is determined that there are not more job transition histories, the process ends.

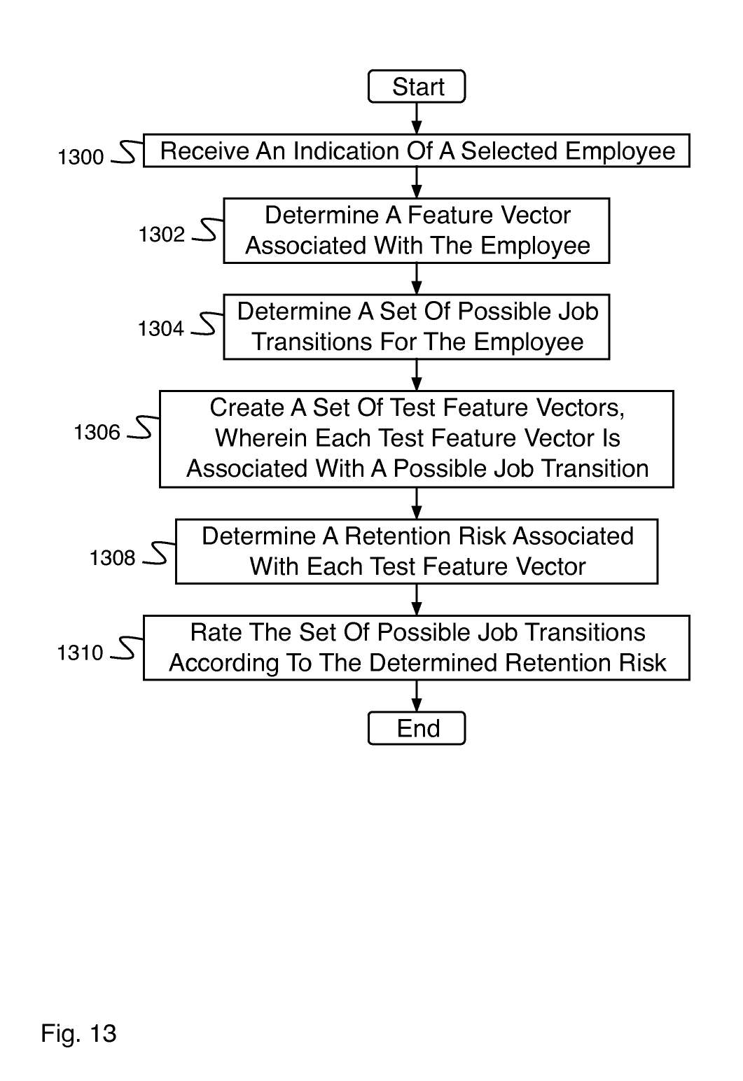

FIG. 13 is a flow diagram illustrating an embodiment of a process for rating job transitions of a selected employee based on a model, using a set of test feature vectors. In some embodiments, the process of FIG. 13 implements 712 of FIG. 7. In the example shown, in 1300, a job transition indication of a selected employee is received. In 1302, a feature vector associated with the employee is determined. In some embodiments, a feature vector is determined using a process as shown in FIG. 12. In 1304, a set of possible job transitions for the employee are determined. In some embodiments, the set of possible job transitions comprises all possible job transitions from the selected employee current job. In some embodiments, the set of possible job transitions is limited to job transitions for which there is data (e.g., job transitions that have a non-zero probability—for example, non-zero probability for a transition for the company data). In 1306, a set of test feature vectors is created, wherein each test feature vector is associated with a possible job transition. In some embodiments, creating a test feature vector comprises adding a possible job transition to the feature vector associated with the employee. In 1308, a retention risk associated with each test feature vector is determined. In some embodiments, the retention risk is determined using a model. In 1310 the set of possible job transitions is rated according to the determined retention risk.

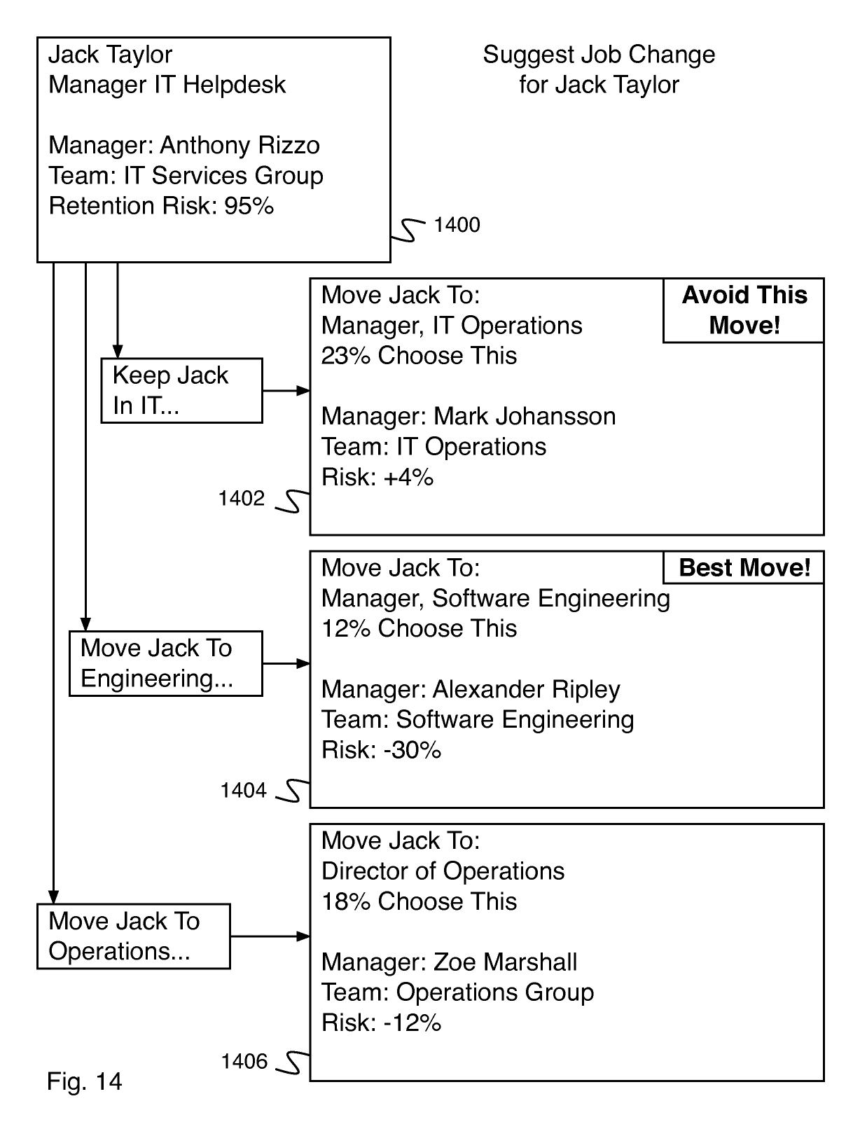

FIG. 14 is a diagram illustrating an embodiment of a user interface for a retention risk mitigation system. In some embodiments, the user interface of FIG. 14 is provided by retention risk mitigation system 106 of FIG. 1 (e.g., a rater). In the example shown, the user interface displays employee information (e.g., employee information 1400) describing an employee for which a job change is desired. For example, the user interface provides employee information associated with the selected employee (e.g., name, title, manager, team, etc.), and a current retention risk (e.g., 95% chance of leaving in the next year. In some embodiments, a manager uses the user interface of FIG. 14 in order to determine the best of a set of possible promotions to give an employee for which it is desired to reduce the retention risk (e.g., increase the likelihood that the employee will stay with the company). In the example shown, employee information 1400 displays the employee position, team, and manager, and a retention risk for the employee. In some embodiments, the retention risk for the employee is determined using a system for retention risk mitigation. In the example shown, the employee Jack Taylor is the manager of the information technology (e.g., IT) helpdesk and has a 95% retention risk. The user interface additionally displays various job change options and the effects they are determined to have (e.g., a change in retention risk or retention risk change). Job change option 1402 displays job information describing a situation in the event it is decided to keep Jack in IT. Jack could be promoted to Manager of IT Operations. Job change information is also provided (e.g., new manager information and new team information—for example, Mark Johansson and IT operations, respectively). Job information 1402 additionally displays a retention risk in the event this change is made. In the example shown, retention risk increases by 4%. It is determined that this is not a desirable move (e.g., because it increases retention risk). In some embodiments, job information 1402 additionally displays an indication in order to warn the user that the job change is not a desirable move (e.g., “Avoid This Move” is indicated in the event that the risk increases more than a threshold amount—for example, more than 0%, more than 5%, etc.). Job change 1404 displays job information describing a situation in the event it is decided to move Jack to engineering. Jack could be promoted to Manager of Software Engineering. Job change information is also provided (e.g., new manager information and new team information—for example, Alexander Ripley and Software Engineering, respectively). In the example shown, retention risk decreases by 30%. It is determined that this is a desirable move (e.g., because it decreases retention risk). In some embodiments, job information 1404 additionally displays an indication in order to indicate that this is a preferred or best move of the set of moves displayed (e.g., “Best Move” or “Preferred Move” in the event that the risk decreases the most for the change (e.g., best), or second most (e.g., preferred), or above a first threshold (e.g., best for decrease in risk >50%) or between a first threshold and a second threshold (e.g., preferred for decrease in risk >25% but <50%), etc.). Job change 1406 displays job information describing a situation in the event it is decided to move Jack to operations. Jack could be promoted to Director of Operations. Job change information is also provided (e.g., new manager information and new team information—for example, Zoe Marshall and Operations Group, respectively). In the example shown, retention risk goes down by 12%.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for rating job transitions, comprising:
a probability determiner for determining a set of probabilities, wherein each probability of the set of probabilities comprises a ratio of a number of transitions from a first job to a second job divided by a number of total employees in the first job;
a grouper for determining a group of job transition histories wherein each job transition history is associated with one employee;
a filter for determining a subset of job transition histories from the group of job transition histories by filtering based at least in part on a transition characteristic;
a normalizer for determining a model set of job transition histories by normalizing the subset of job transition histories;
a feature vector extractor for determining a set of feature vectors using the model set of job transition histories, wherein each feature vector is based at least in part on a job transition history of an employee and on the set of probabilities;
a model builder for determining a model based at least in part on the set of feature vectors; and
a rater for rating potential job transitions of a selected employee based on the model using a set of test feature vectors.

2. The system of claim 1, wherein the rater provides the rating for the potential job transitions of the selected employee.

3. The system of claim 2, wherein the rater provides a current retention risk, a current performance, and employee information associated with the selected employee.

4. The system of claim 2, wherein the rating comprises a risk change for leaving in a next year.

5. The system of claim 2, wherein the rater provides a job change information.

6. The system of claim 5, wherein the job change information comprises new manager information.

7. The system of claim 5, wherein the job change information comprises new team information.

8. The system of claim 2, wherein the rater provides an indication associated with a job change.

9. The system of claim 1, wherein a first feature of each feature vector is associated with a first job transition.

10. The system of claim 9, wherein in the event the first job transition is not present in a first job transition history, the first feature of the feature vector associated with the first job transition history is assigned a value of zero.

11. The system of claim 9, wherein in the event the first job transition is present in the first job transition history, the first feature of the feature vector associated with the first job transition history is assigned a value based at least in part on a probability of the set of probabilities.

12. The system of claim 11, wherein the value based at least in part on the probability of the set of probabilities comprises an inverse of the probability of the set of probabilities.

13. The system of claim 9, wherein in the event the first job transition is present in the first job transition history, the first feature of the feature vector associated with the first job transition history is assigned a value based at least in part on a date associated with the first job transition.

14. The system of claim 13, wherein the value based at least in part on the date associated with the first job transition is scaled by a scaling factor dependent on the date.

15. The system of claim 14, wherein the scaling factor comprises a decaying scale factor of one of the following forms: linear, quadratic, or exponential.

16. The system of claim 1, wherein the rater determines a feature vector associated with the selected employee.

17. The system of claim 16, wherein the rater determines a set of possible job transitions associated with the selected employee.

18. The system of claim 17, wherein the set of possible job transitions comprises all possible job transitions associated with the employee for which a probability has been determined by the probability determiner.

19. The system of claim 17, wherein the each feature vector of the set of test feature vectors comprises the feature vector associated with the selected employee modified to include one of the set of possible job transitions.

20. The system of claim 17, wherein rating a job transition comprises comparing a retention risk determined by applying the model to the test feature vector associated with the job transition with a retention risk determined by applying the model to the feature vector associated with the selected employee.

21. A method for rating job transitions, comprising:
determining, using a processor, a set of probabilities, wherein each probability of the set of probabilities comprises a ratio of a number of transitions from a first job to a second job divided by a number of total employees in the first job;
determining a group of job transition histories wherein each job transition history is associated with one employee;
determining a subset of job transition histories from the group of job transition histories by filtering based at least in part on a transition characteristic;
determining a model set of job transition histories by normalizing the subset of job transition histories;
determining a set of feature vectors using the model set of job transition histories, wherein each feature vector is based at least in part on a job transition history of an employee and on the set of probabilities;
determining a model based at least in part on the set of feature vectors; and
rating job transitions of a selected employee based on the model, using a set of test feature vectors.

22. A computer program product for rating job transitions, the computer program product being embodied in a non-transitory computer readable storage medium and comprising computer instructions for:
determining, using a processor, a set of probabilities, wherein each probability of the set of probabilities comprises a ratio of a number of transitions from a first job to a second job divided by a number of total employees in the first job;
determining a group of job transition histories wherein each job transition history is associated with one employee;
determining a subset of job transition histories from the group of job transition histories by filtering based at least in part on a transition characteristic;
determining a model set of job transition histories by normalizing the subset of job transition histories;
determining a set of feature vectors using the model set of job transition histories, wherein each feature vector is based at least in part on a job transition history of an employee and on the set of probabilities;
determining a model based at least in part on the set of feature vectors; and
rating job transitions of a selected employee based on the model, using a set of test feature vectors.
